(19) United States
(12) Patent Application Publication
(10) Pub. No.: US 2011/0109060 A1
(43) Pub. Date: May 12, 2011

(54) ACTIVE SHOCK-DAMPING SYSTEM

(75) Inventors: David M. Earle, Watsonville, CA (US); Luther M. Beale, Portland, OR (US)

(73) Assignee: Praxis Works LLC, Watsonville, CA (US)

(21) Appl. No.: 12/872,986

(22) Filed: Aug. 31, 2010

Related U.S. Application Data
(60) Provisional application No. 61/238,583, filed on Aug. 31, 2009.

(51) Int. Cl. B62K 25/04; G06F 19/00; B62K 3/02

(52) U.S. Cl. 280/283; 701/37

(57) ABSTRACT

Bicycles and bicycle suspension systems including a sensor configured to sense a force or torque exerted by a rider on a bicycle, and a suspension adjustment mechanism configured to adjust a parameter of the bicycle suspension system in response. A controller or suspension management unit may be provided to receive data from the sensor, determine a corresponding suspension configuration, and transmit a suitable signal to the suspension adjustment mechanism. Accordingly, desired suspension characteristics may be achieved under various riding conditions.

### CROSS-REFERENCE TO RELATED APPLICATION(S)

This application claims priority under 35 U.S.C. §119 and applicable foreign and international law of U.S. Provisional Patent Application Ser. No. 61/238,583 filed Aug. 31, 2009 and is hereby incorporated by reference in its entirety.

### BACKGROUND

A bicycle with a suspension system is useful for reducing the discomfort of rough terrain and for ensuring efficient power transfer and better handling over uneven surfaces. However, implementing a suspension on a bicycle may cause the suspended portion to oscillate vertically when the bicycle is pedaled, due to variations in drive torque and reaction forces arising from movement of the rider's body. These vertical oscillations are considered inefficient, because they represent a portion of the energy input by the rider that is lost to friction rather than transformed into motion. Furthermore, vertical oscillations during pedaling may lead to difficulty controlling the bicycle in rough terrain.

One way that existing bicycle suspensions address these problems is by adopting suspension geometries in which pedaling forces induce reaction forces which counteract the forces that would otherwise lead to vertical oscillations. Solutions of this type, which do not actively damp a shock absorber but rather attempt to reduce the net oscillatory force during pedaling, may be termed “geometric” or “passive” solutions. Examples of this type of design can be are known, for example, as the “virtual pivot point” (VPP), “instant center tracking” (ICT), four-bar/Horst Link and Dave Weagle (i.e., DW-Link) suspension systems.

Another method of compensating for the inefficiencies that occur when a suspension system oscillates undesirably during pedaling is to design and implement a shock damper mechanism configured to actively damp pedaling-induced oscillations. Solutions of this type naturally may be termed “active” solutions. Examples of existing active shock damping systems include the “ProPedal” and “TerraLogic” systems manufactured by Fox Racing Shox, Inc., the “5th Element” manufactured by Progressive Suspension, Inc., and the “Motion Control” damping system manufactured by the SRAM Corporation. Existing active damping systems can further be classified by the design used to provide a reactive force to terrain variation. A first class of designs uses some form of a coil spring to return a compressive force to the shock absorber, while a second class of designs works via reversible compression of an enclosed fluid volume (typically air).

While specific rear suspension geometries and custom damper designs can be effective in reducing oscillations under some circumstances, these approaches may compromise bump-absorbing performance or limit bicycle design freedom. In addition, existing suspension systems that alter damper performance in response to terrain variations typically act only after the bicycle has encountered the variation. The time lag between the cause (terrain variation) and effect (reaction force) of the damping correction can make it very difficult for the rider to predict how the bike will respond from one moment to the next and can therefore affect the rider's balance. Specialized BRAIN is an example of a system such as this, as it uses a small valve that opens when the bike hits a bump and thus allows the shock to move, whereas the shock is otherwise in a locked out state.

Prior art systems typically also encounter the problem that a system which is stable and allows efficient force transmission from the rider to the surface on smooth terrain is often less able to compensate for terrain variations and encountered obstacles. Likewise, a system which compensates well for terrain variations (i.e. “soaks up the bumps” well) has a greater tendency to allow relatively more power loss from the rider's pedaling efforts. An optimal shock-damping system would implement both a firm setup for efficient power transmission and a softer setup to compensate for wide variations in terrain, while simultaneously reducing the time lag that causes unpredictable handling.

One shock absorber system that attempts to adjust shock damping based on feedback from a parameter of the bicycle is disclosed in US. Patent Application No. 2009/0192673 assigned to the Cannondale Bicycle Corporation of Bethel, Conn. This application discloses sensing parameters such as crank speed, gear selection, rear suspension position, and wheel velocity, and using data from the sensors to control a valve box that affects shock damping. However, this system suffers from the drawback that it does not directly sense rider forces applied to the bicycle, which in many cases are the best indication of the appropriate level of shock damping. Accordingly, an active shock-damping system is needed that senses rider forces and/or torques applied to a bicycle and adjusts shock damping in response.

### BRIEF DESCRIPTION OF THE DRAWINGS

FIG. 1 is a schematic representation of a control unit and potential inputs and outputs that may be used in an active shock-damping system.

FIG. 2 depicts a first embodiment of an active shock-damping system.

FIG. 3 depicts a second embodiment of an active shock-damping system

FIG. 4 is a schematic representation of a potential arrangement of elements in an active shock-damping system.

FIG. 5 is a schematic representation of an input and output process that may be used to control an active shock-damping system.

FIG. 6 is a schematic representation of a selected input and a selected control unit that may be used with multiple potential outputs in an active shock-damping system.

### DETAILED DESCRIPTION

The present disclosure is related to human-powered cycles and associated components such as frames, sub-frames, suspension dampers, suspension springs, and control mechanisms and sensors that influence the interactions between these elements. The described active shock-damping systems change one or more damping characteristics in response to feedback from a sensor coupled to a portion of the bicycle, enabling the damper to damp pedaling-induced oscillations under a set of chosen conditions without compromising performance in other situations and conditions. In some embodiments, the disclosed systems are configured to sense one or more forces and/or torques applied to a bicycle by a rider, and to adjust shock damping in response.

### A. OVERVIEW

The disclosed active shock-damping system responds in real-time or near real-time to the actions of a rider as measured through sensors mounted on or otherwise coupled to a bicycle. Accordingly, the disclosed active shock-damping system removes the need for offsetting pedaling-induced oscillations with modified rear suspension geometries or dampers that respond retroactively to variations in terrain. In a typical embodiment, a torque sensor assembly placed appropriately to measure torque in a bicycle drive train is used as an input in a control system for a shock absorber damper. One advantage of the disclosed torque-sensing embodiment is that the active shock-damping system will adopt appropriate damping characteristics independent of terrain variations.

The disclosed embodiments of an active shock-damping system may be configured to use existing shock damper technology in a new way. Specifically, a torque sensing control unit coupled to a shock absorber system may result in shock absorption that responds directly to rider torque input and adjusts damping accordingly. The disclosed active shock-damping system is particularly suitable for use with bicycles, although a similar system may be adaptable for use in or with other vehicles, such as motorcycles, all-terrain vehicles, or the like.

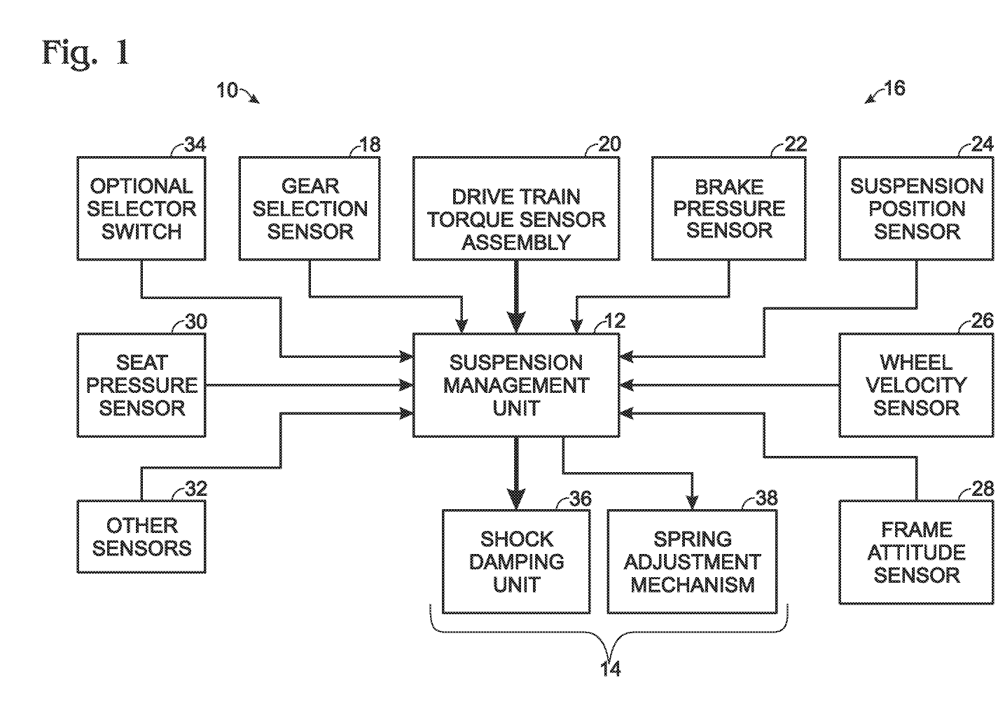

FIG. 1 is a schematic representation of an active shock-damping system, generally indicated at 10, according to aspects of the present teachings. System 10 includes a suspension management unit (or controller) 12, one or more suspension modification assemblies, generally indicated at 14, and one or more sensors, generally indicated at 16.

Sensors 16 may include one or more different types of sensors configured to sense a condition under which it is desirable to change one or more characteristics of the vehicle suspension system. For example, sensors 16 may sense chain tension, crank arm deflection, crank spider deflection, bottom bracket spindle deflection, wheel hub shell deflection, pedal spindle deflection, frame deflection, or any other data that corresponds to the rider's pedaling input. Sensors 16 may, additionally or alternatively, sense data such as gear selection, brake pressure, frame attitude (for example, relative to the horizontal position), suspension position, ground velocity, vertical acceleration of the sprung and/or unsprung masses, or any other data that may be of use in determining the desirability of changing one or more characteristics of the vehicle suspension system.

Accordingly, sensors 16 may include a gear selection sensor 18, a drive train torque sensor assembly 20, a brake pressure sensor 22, a suspension position sensor 24, a wheel velocity sensor 26, a frame attitude sensor 28, and/or a seat pressure sensor 30, among other sensors generally indicated at 32. These sensors may measure their selected input electronically, they may have direct mechanical interaction with another component of the vehicle, or they may employ some combination of these measuring methods. Additionally, sensors 16 may include a manual selector switch 34 to permit the rider to directly input a signal to suspension management unit 12.

Each of sensors 16 is configured to sense a parameter of a bicycle, a bicycle suspension system, and/or an impact of a rider on the bicycle, and to produce a signal corresponding to the measured parameter. For example, torque sensor assembly 20 may be configured to sense torque applied by a user to a bicycle drive train and to produce a corresponding torque signal. More specifically, torque sensor assembly 20 may be disposed in a bicycle pedal spindle, and may be configured to sense deflection of the pedal spindle from its neutral position. Similarly, torque sensor assembly may be configured to sense deflection of any other portion of the bicycle drive train from a neutral position. In addition, torque sensor assembly may be disposed in a bicycle rear wheel hub, and may be configured to sense torque exerted in the hub by any suitable method. Torque sensor assembly 20 also may be configured to sense chain tension, in which case it may also be characterized as a chain tension sensor.

Suspension management unit 12, which may also be referred to as a controller, is configured to receive the signal produced by one or more of sensors 16 and in response to provide a corresponding suspension management output signal. For example, suspension management unit 12 may be configured to receive a torque signal produced by torque sensor assembly 20 and to provide a suspension management output signal corresponding to the torque signal. The suspension management output signal also may be characterized as a suspension modification signal, as it generally includes information sufficient to modify or adjust a characteristic of the suspension system of the bicycle in response to the signal received from one or more of sensors 16. For example, the suspension management unit may be configured to determine a desired shock damping configuration based upon the signal received from the sensor(s), and to produce a suspension modification signal that corresponds to the desired shock damping configuration.

A shock damping configuration may be communicated to a shock absorber in the form of a suspension management signal by any suitable method, such as through a wire or wirelessly. Suspension management unit 12 may include one or more of a dedicated electronic circuit, a programmable logic controller, a computer, an electronic device such as a mobile phone, cyclo-computer, GPS unit, or any other suitable device. Unit 12 may determine the appropriate shock damping configuration in response to an input or set of inputs, for example, using an algorithm, a look-up table, or an equation. Unit 12 may also be adjusted to through switches, dials, or other devices, so that the appropriate shock damping configuration changes for a given input or set of inputs. A change in the response of unit 12 to a given input or set of inputs may be desirable, for example, to compensate for different riders, a change in riding style, or a change in terrain type.

Suspension modification assembly 14 may include a shock damping unit 36, a spring adjustment mechanism 38, or any other appropriate adjustable shock absorber damping device. A suitable suspension modification assembly will be configured to allow adjustment of one or more characteristics of a shock absorber, such as damping response rate or spring tension, in response to a signal from suspension management unit 12. According to the present teachings, such an adjustment will be made when unit 12 determines that altering the shock absorber characteristic(s) would result in more efficient operation of the vehicle.

To make an adjustment in shock absorption characteristics, the controller or suspension management unit 12 sends a signal either by wire or wirelessly to an adjustment mechanism such as suspension modification assembly 14. In response, suspension modification assembly 14 may, for example, change a valve orifice diameter, vary clearance between parts, change the pre-load value on a check-valve spring, change the spring rate on a check valve spring, or open or close a hydraulic circuit. These adjustments change spring characteristics and/or alter hydraulic fluid flow through various orifices and passageways within system 10, thereby changing the damping response rate of the shock-damping system. For example, increasing an orifice diameter may permit more hydraulic fluid to flow through the orifice over a fixed time, increasing the softness of the system. Conversely, decreasing an orifice diameter may restrict fluid flow, providing greater resistance to motions of the suspension system and a correspondingly firmer ride.

In addition to the shock absorber responding to the control system by changing typical shock apparatus such as valve orifice size or opening and closing a hydraulic circuit, it is also possible that the electronic signal can create a change in viscosity of the fluid that is used in the damping circuit. For example, a magneto-rheostatic fluid could be used within a damping circuit, to adjust damping in response to a signal generated by the suspension management unit. Such a signal would be sent in response to sensor data in much the same manner as with other methods of adjusting damping.

In some cases, systems according to the present disclosure may include a plurality of sensors, suspension management units, and/or suspension modification assemblies operating in conjunction with each other. For example, an active shock-damping system may include first and second sensors configured to measure different forces or torques exerted on a bicycle, and/or different properties of the bicycle. In this case, the first sensor would be configured to generate a first signal corresponding to parameter it measures, and the second sensor would be configured to generate a second signal corresponding to parameter it measures. The suspension management unit or units would then be configured to receive both signals generated by the sensors, and to generate one or more suspension modification signals based on both the first and second signals received from the sensors. The same principal can be extended to systems involving any desired number of sensors, suspension management units, and suspension modification assemblies.

### B. EXAMPLES

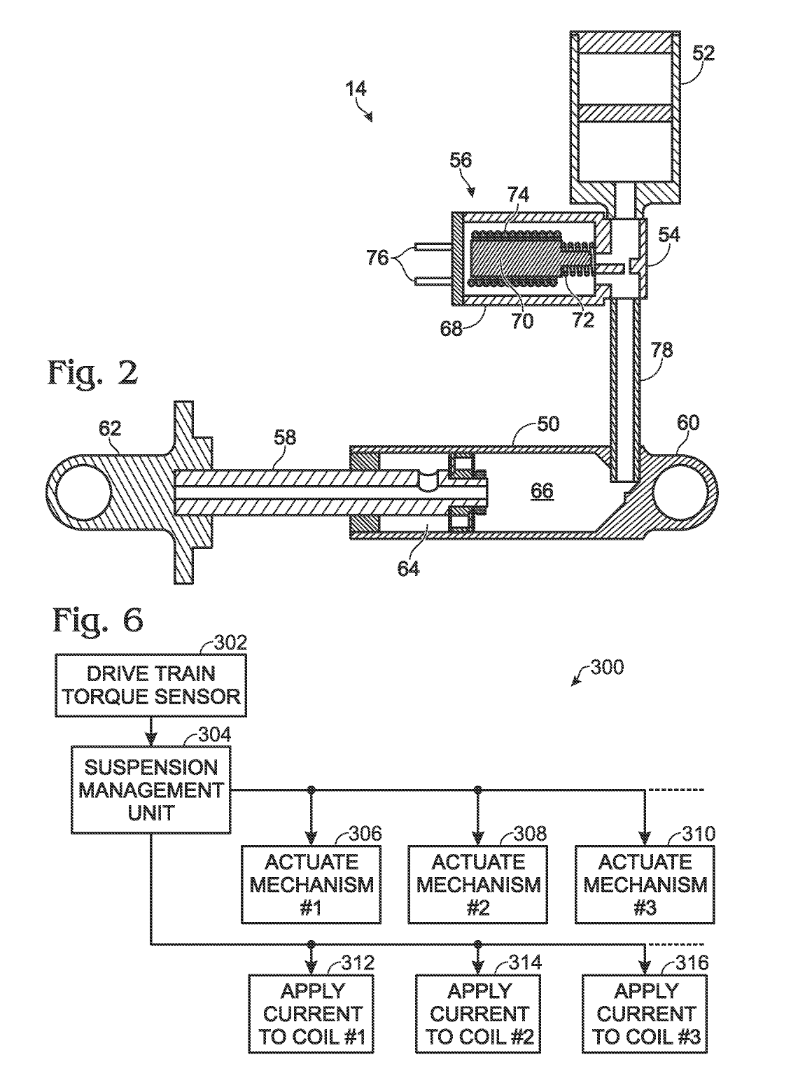

FIGS. 2 and 3 depict more specific aspects of an exemplary suspension modification assembly 14. Suspension modification assembly 14 depicted in FIGS. 2 and 3 includes a shock absorber 50 coupled to a controlled damper 52, via a valve body 54. Valve body 54 may be operated by a solenoid valve, generally indicated at 56. Shock absorber 50 may operate through a mechanism that includes a piston 58 coupled to components of a bicycle frame via mounting points 60, 62 (see FIG. 2). Shock absorber 50 contains a first working chamber 64 and a second working chamber 66, separated by piston 58. First working chamber 64 and second working chamber 66 may or may not be fluidically coupled with each other.

Solenoid valve 56 includes a solenoid body 68 that houses a core 70. Core 70 may be supported in an internal portion of body 68 by a spring 72. In the disclosed electronic solenoid, core 70 is wrapped by a wire in a plurality of coils 74 capable of carrying an electric current to and from suspension management unit 12 via leads 76. Solenoid valve 56 may open or close in response to an electric current sent via leads 76, due to a magnetic field induced by the electric current in coils 74. For example, solenoid valve 56 may remain in the open position when leads 76 carry no electric current, and may change to a closed position when leads 76 are energized. Alternatively, solenoid valve 56 may remain in the closed position when leads 76 carry no electric current, and change to an open position when leads 76 are energized.

When solenoid valve 56 is open, second working chamber 66 is fluidically coupled with controlled damper 52 via valve body 54 and tubing 78. Controlled damper 52 may be configured to act as a fluid friction reservoir, providing a compressible reservoir of fluid that will permit increased motions of piston 58. This corresponds to a relatively lesser amount of damping (i.e., a less stiff shock absorber) when valve 56 is open. The amount of damping may depend on factors such as the degree to which valve 56 is open, the characteristics of the fluid within damper 52, and the presence of one or more membranes and/or fluid apertures within the damper. On the other hand, when solenoid valve 56 is completely closed, chamber 66 is fluidically decoupled from damper 52, and the fluid within damper 52 is unavailable to relieve pressure generated by piston 58 and to allow increased motion of the piston. This corresponds to a relatively greater amount of damping (i.e., a stiffer shock absorber).

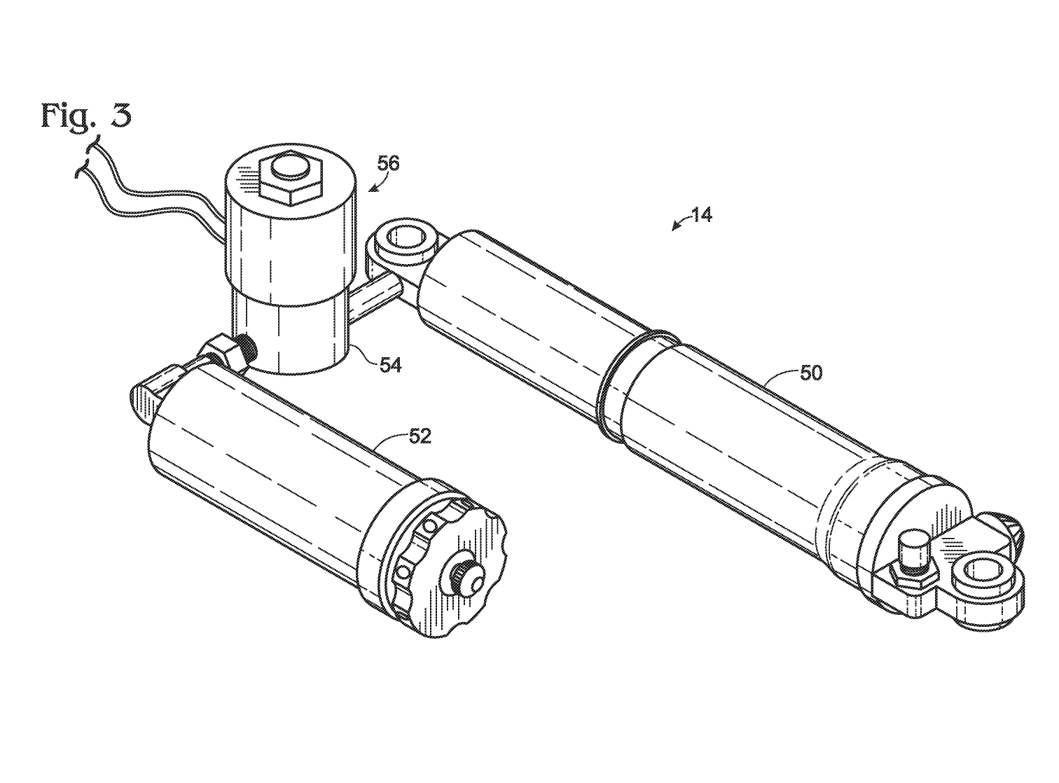

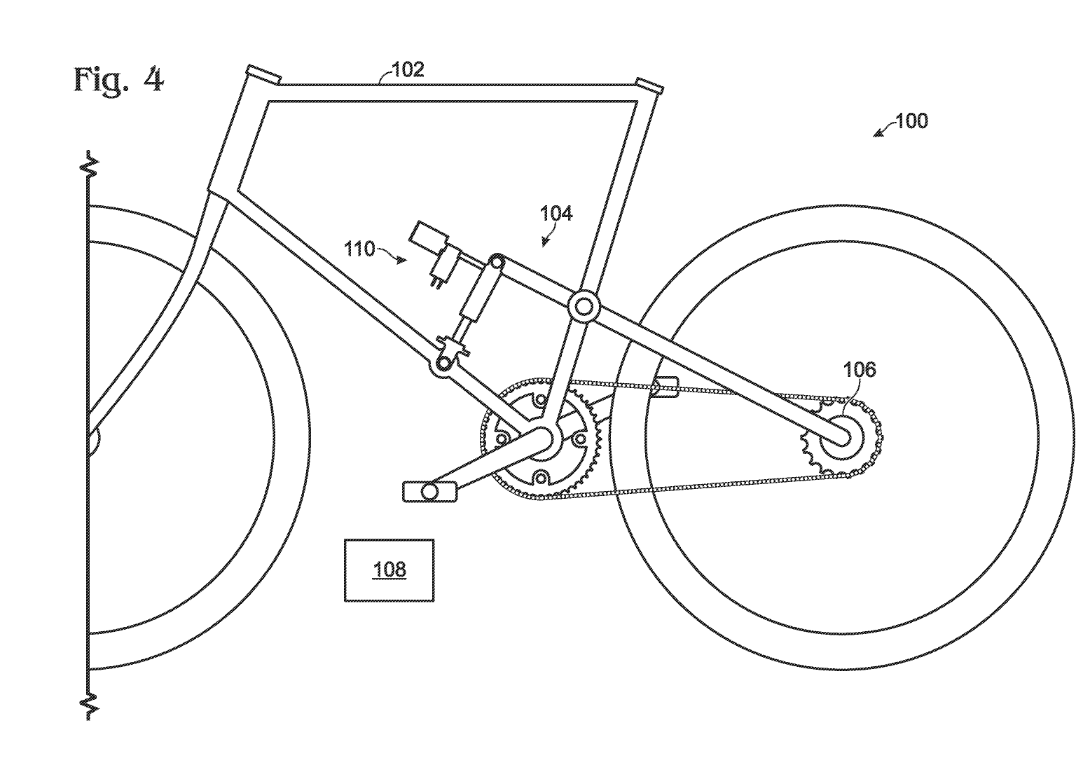

FIG. 4 is a schematic representation of a bicycle, generally indicated at 100, including an active shock-damping system according to aspects of the present disclosure. Bicycle 100 includes a bicycle frame 102, and a rear suspension system coupled to the bicycle frame and generally indicated at 104. Rear suspension system 104 is an active shock-damping system that operates according to the same principles described above with respect to active shock-damping system 10. Accordingly, rear suspension system 104 includes a sensor assembly 106, a controller 108, and a suspension modification assembly 110. Although FIG. 4 shows an active shock-damping rear suspension system, alternatively or in addition, active shock-damping may be incorporated into a front suspension system.

Sensor assembly 106 is depicted in FIG. 4 as a torque sensor disposed in the rear hub of bicycle 100 and configured to measure torque exerted on the rear hub by a rider's pedaling action. Similarly, a torque sensor may be suitably disposed within or around the bottom bracket or crankset of the bicycle, or attached to any other portion of the bicycle that experiences torque resulting from user input to the bicycle. More generally, the sensor assembly may include one or more sensors configured to sense any force applied by a user to the bicycle, and to produce a corresponding signal.

In some cases, the sensor assembly may be configured to sense a force by measuring the deflection from a neutral position of a portion of the drivetrain of the bicycle. For example, the sensor assembly could be disposed within a pedal spindle of the bicycle and configured to measure deflection of the pedal spindle. Alternatively, the sensor assembly may be configured to measure the tension in the chain of the bicycle, the pressure on the seat of the bicycle, or the pressure exerted on the front or rear brake assembly of the bicycle. More generally still, the sensor assembly may be configured to measure other parameters of the bicycle, such as gear selection, frame attitude, wheel velocity, or shock compression, among others.

Controller 108 is generally configured to receive a signal from the sensor assembly and to generate a corresponding suspension management signal. In FIG. 4, controller 108 is depicted as a “black box” component of the bicycle. This is because the controller can take a wide variety of forms and be disposed in a wide variety of locations. For example, the controller may be incorporated into a multi-purpose electronic device such as a mobile telephone, a cyclo-computer, a global positioning system unit, a heart rate monitor, or a power monitor, among others. In this case, the controller may be disposed on any suitable portion of the bicycle such as the handlebar or stem, or it may be worn or otherwise carried by the rider. Alternatively, the controller may be a dedicated component, such as a programmable logic circuit or any other suitable electronic device, attached to the suspension system (for example, to the suspension modification assembly) or some other portion of the bicycle.

Suspension modification assembly 110 is configured to receive a suspension management signal from the controller, for example through a wire or via a wireless electromagnetic communication, and to adjust a characteristic of the suspension system in response. The adjustment can be accomplished in any of the ways described previously, such as changing a valve orifice diameter, varying clearance between parts, changing the pre-load value on a check-valve spring, changing the spring rate on a check valve spring, or opening or closing a hydraulic circuit. Alternatively, the suspension modification assembly can be configured to create a change in viscosity of the fluid that is used in the damping circuit in response to an electrical signal generated by the controller.

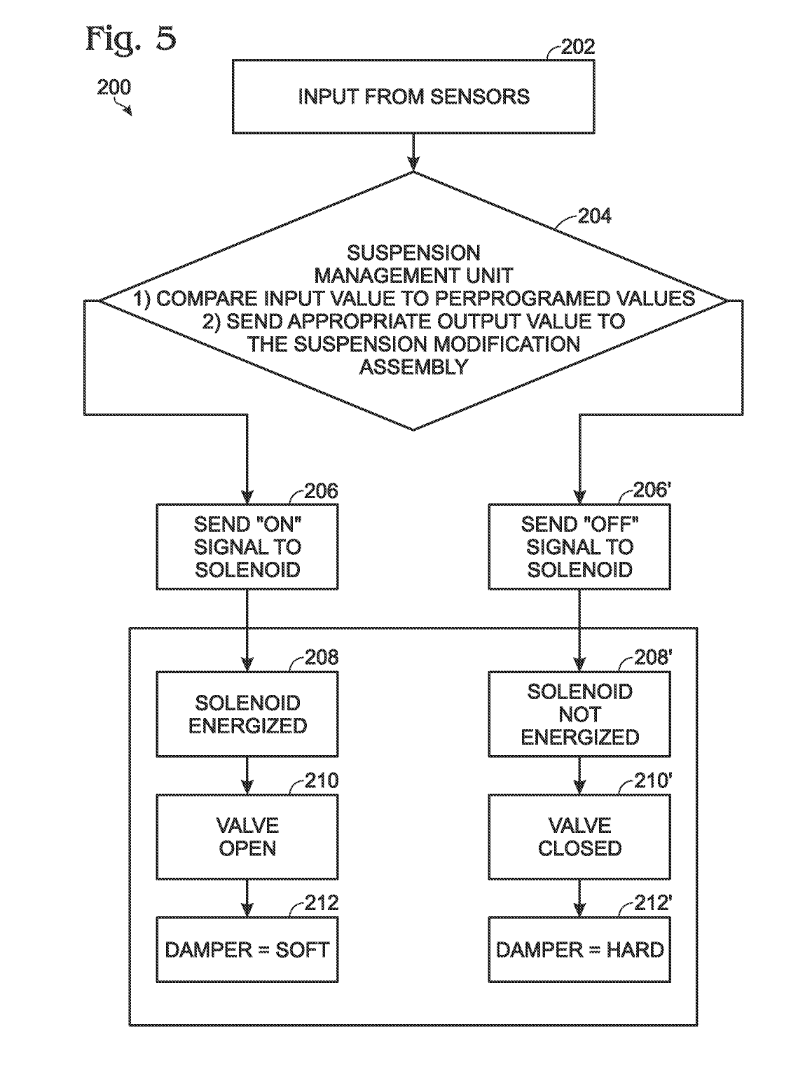

FIG. 5 is a schematic representation of a method, generally indicated at 200, that may be used to control an active shock-damping system. The method operates through interactions of one or more sensors, a controller or suspension management unit, and a suspension modification assembly. All of these components have been previously described in detail. Method 200 may incorporate multiple sensors, and in some cases (such as when it is desirable to control the characteristics of multiple shock absorbers) may incorporate multiple suspension modification assemblies, for example one to control a rear shock absorber and one to control a front shock absorber.

At step 202 of method 200, input is received at one or more sensors attached to a bicycle. As described previously, the sensed input can include data relating to any parameter useful for determining one or more appropriate characteristics of the vehicle suspension system. For example, a torque sensor may detect a torque value at a component of the drive train, such as the crank arms, chain, bottom bracket, pedals, or rear hub. Various other types of sensors, some of which have been described above, also may be used. The sensor then may provide a signal representing the sensed data to the controller or suspension management unit.

At step 204, one or more signals from the sensor(s) are received at the suspension management unit and the sensed parameter value corresponding to the signal is compared to a preprogrammed value, for example in a lookup table or according to an algorithm. At steps 206, 206′ the suspension management unit sends an appropriate control signal to a suspension modification assembly, in response to the signal from the sensor. In FIG. 5, these steps are depicted as the discrete alternatives of sending either an “on” signal or an “off” signal to a solenoid valve assembly, but more generally the suspension modification assembly may send a continuous range of signals to any suspension component configured to modify a suspension characteristic.

At steps 208, 208′, the suspension modification assembly responds to the signal received from the suspension modification unit. In the depicted method, this causes the solenoid to be either energized or not energized, but again more general responses are possible, such as intermediate states of a solenoid, or continuous or discrete responses of other suspension components. At steps 210, 210′ of the depicted method, a valve of the solenoid assembly becomes either open or closed in response to the energy state of the solenoid, causing the damper of a corresponding shock absorber to become soft or hard respectively at steps 212, 212′. In general, methods according to the present disclosure may include a wide range of modification of suspension components, resulting in any desired change in shock absorption characteristics.

In some cases utilizing a solenoid valve, it may be desirable that the default state of the solenoid valve is open, corresponding to relatively greater shock absorption and a softer ride. For example, this may be appropriate for downhill mountain biking, where relatively little time is spent pedaling. In other cases, it may be desirable that the default state of the solenoid valve is closed, corresponding to relatively lesser shock absorption and a stiffer shock. For example, this may be appropriate for cross country mountain biking, where a relatively large amount of time is spent pedaling. A switch mechanism may be provided to change from one default state to another, or a controller such as the suspension management unit or a separate control unit may be configured to automatically switch default modes depending on the terrain as sensed through one or more sensors.

FIG. 6 is a schematic representation of an exemplary active shock-damping system, generally indicated at 300, that may incorporate a plurality of suspension management components. As depicted in FIG. 6, the exemplary active shock-damping system includes a drivetrain torque sensor 302 and a suspension management unit 304. Alternatively, system 300 may include any desired number of sensors, such as three or more, and alternatively or additionally, system 300 may include a plurality of controllers or suspension management units. Furthermore, sensor 302 need not be a torque sensor, but in other embodiments may take the form of any sensor configured to sense a parameter of the bicycle, as described previously.

In the embodiment of FIG. 6, suspension management unit 304 (and any additional controllers) is configured to send one or more control signals to actuate a plurality of suspension modification mechanisms 306, 308, 310, which may, for example, be a plurality of solenoid valves. The actuated suspension modification mechanisms cause a plurality of suspension modification actions, for example by applying electric current to a plurality of solenoid coils 312, 314, 316, causing a change in state of the corresponding solenoid valves. Accordingly, system 300 allows various suspension characteristics to be altered as different ride conditions are sensed. The suspension management unit may activate, partially activate, or leave inactive one or more suspension modification assemblies or solenoid valves in any desired combination to fine-tune suspension response for best effect in given terrain.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, neither requiring nor excluding two or more such elements. Furthermore, any aspect shown or described with reference to a particular embodiment should be interpreted to be compatible with any other embodiment, alternative, modification, or variance.

I claim:

1. A bicycle suspension system, comprising:
at least one torque sensor assembly configured to sense torque applied by a user to a bicycle drive train and to produce a corresponding torque signal;
a controller configured to receive the torque signal and in response to provide a corresponding suspension management output signal; and
an adjustment mechanism configured to receive the suspension management output signal and in response to adjust a characteristic of a bicycle suspension system.

2. The bicycle suspension system of claim 1, wherein the torque sensor is configured to transmit the torque signal to the controller wirelessly.

3. The bicycle suspension system of claim 1, wherein the torque sensor is disposed in a bicycle pedal spindle.

4. The bicycle suspension system of claim 1, wherein the torque sensor is disposed in a bicycle rear wheel hub.

5. The bicycle suspension system of claim 1, wherein the torque sensor is configured to sense torque by sensing deflection of a portion of the bicycle drive train.

6. The bicycle suspension system of claim 1, wherein the adjusted characteristic of the suspension system is selected from the set consisting of damping response rate and spring tension.

7. A bicycle suspension system, comprising:
a first sensor configured to measure a parameter corresponding to an impact of a rider on a bicycle and to generate a first signal corresponding to the measured parameter, wherein the parameter is selected from the group consisting of (i) torque exerted by the rider on a drivetrain component of the bicycle, (ii) tension produced by the rider in a chain of the bicycle, (iii) braking pressure produced by the rider operating a brake of the bicycle, and (iv) pressure exerted by the rider on a seat of the bicycle;
a suspension management unit configured to receive the first signal and to generate a corresponding suspension modification signal; and
a suspension modification assembly configured to receive the suspension modification signal and to adjust a characteristic of a shock absorber of the bicycle in response.

8. The bicycle suspension system of claim 7, wherein the suspension management unit is configured to determine a desired shock damping configuration based upon the first signal, and wherein the suspension modification signal corresponds to the desired shock damping configuration.

9. The bicycle suspension system of claim 7, wherein the first sensor is configured to sense deflection of a drivetrain component from a neutral position.

10. The bicycle suspension system of claim 9, wherein the first sensor is configured to sense deflection of a pedal spindle of the bicycle.

11. The bicycle suspension system of claim 7, wherein the first sensor is configured to sense torque exerted in a rear wheel hub of the bicycle.

12. The bicycle suspension system of claim 7, further comprising:
a second sensor configured to measure a property of the bicycle selected from the group consisting of gear selection, frame attitude, suspension position, bicycle velocity and bicycle acceleration;
wherein the second sensor is configured to generate a second signal corresponding to the measured property; and
wherein the suspension management unit is configured to receive the second signal and to generate the suspension modification signal based on both the first and second signals.

13. A bicycle, comprising:
a bicycle frame; and
a rear suspension system coupled to the bicycle frame and including:
a sensor assembly configured to sense a force applied by a user to a bicycle and to produce a corresponding signal;
a controller configured to receive the signal from the sensor assembly and to generate a corresponding suspension management signal; and
a suspension modification assembly configured to receive the suspension management signal and to adjust a characteristic of the suspension system in response.

14. The bicycle of claim 13, wherein the sensor assembly is configured to sense the force by measuring deflection from a neutral position of a portion of a drivetrain of the bicycle.

15. The bicycle of claim 14, wherein the sensor assembly is disposed within a pedal spindle of the bicycle and is configured to measure deflection of the pedal spindle.

16. The bicycle of claim 13, wherein the sensor assembly is configured to sense the force by measuring torque exerted on a rear hub of the bicycle.

17. The bicycle of claim 13, wherein the sensor assembly is configured to sense the force by measuring tension in a chain of the bicycle.

18. The bicycle of claim 13, wherein the sensor assembly is configured to sense the force by measuring pressure on a seat of the bicycle.

19. The bicycle of claim 13, wherein the sensor assembly is configured to sense the force by measuring pressure exerted on a brake assembly of the bicycle.

20. The bicycle of claim 13, wherein the controller is incorporated into a multi-purpose electronic device chosen from the set consisting of a mobile telephone, a cyclo-computer, and a global positioning system unit.
